(19) United States
(12) Patent Application Publication
(10) Pub. No.: US 2016/0147712 A1
(43) Pub. Date: May 26, 2016

(54) DYNAMICAL METHODS FOR SOLVING MIXED-INTEGER OPTIMIZATION PROBLEMS

(71) Applicant: BIGWOOD TECHNOLOGY, INC., Ithaca, NY (US)

(72) Inventors: Hsiao-Dong Chiang, Ithaca, NY (US); Tao Wang, Ithaca, NY (US); Bin Wang, Ithaca, NY (US)

(73) Assignee: Bigwood Technology, Inc., Ithaca, NY (US)

(21) Appl. No.: 14/903,203

(22) PCT Filed: Jul. 30, 2013
(86) PCT No.: PCT/US13/52734

§ 371 Date: Jan. 6, 2016

(51) Int. Cl. G06F 17/11

(52) U.S. Cl. CPC G06F 17/11

(57) ABSTRACT

A dynamical method and system generate a global optimal solution to a mixed integer nonlinear programming (MINLP) problem, where a part or all of optimization variables of the MINLP problem are restricted to have discrete values. Relaxed continuous problems of the MINLP problem are generated. For each relaxed continuous problem that has an integer solution with an objective value superior to a current bound, the method updates the current bound with the objective value, computes a set of stable equilibrium points (SEPs) around the integer solution in a nonlinear dynamical system associated with the relaxed continuous problem, identifies from the SEPs a set of starting points for the MINLP problem, and computes a set of integer solutions to the MINLP problem with progressively tightened bounds from the starting points using an MINLP solver. The global optimal solution is generated based on the integer solutions.

### TECHNICAL FIELD

Embodiments of the invention pertain to the field of mathematical analysis and modeling, nonlinear programming and optimization technology. More particularly, the invention pertains to dynamical methods for obtaining global optimal solutions to mixed integer nonlinear programming (MINLP) problems.

### BACKGROUND

Many theoretical and practical problems can be formulated as a general constrained nonlinear optimization problem of the following form:

$$\begin{matrix}min & f ( x ) \\ s . t & {h}_{i} ( x ) = 0 , i ∈ ɛ = \{ 1 , … , {n}_{ɛ} \} \\ & {g}_{j} ( x ) \leq 0 , j ∈ = \{ 1 , … , \} \\ & x ∈ {R}^{n}\end{matrix} \qquad ( 1.1 )$$

where the objective function f(x), the nonlinear equality constraints hᵢ(x), iεε={1, . . . , n_{ε}} and the nonlinear inequality constraints gⱼ(x), jε [symbol] ={1, . . . , n [symbol] } are all twice differentiable; that is, they all belong to C²:Rⁿ→R. It is noted that maximization problems are also readily covered by (1.1) since

max f(x)

is equivalent to

min−f(x).

Therefore, without loss of generality, only minimization will be considered in the following description of the optimization problems. Because of the nonlinearity and nonconvexity of the objective and constraint functions, a real world problem usually contains many local optimal solutions. Thus, obtaining a global optimal solution to (1.1) is of primary importance in real applications. Complexity of the problem (1.1) will be dramatically increased if a part or all of the optimization variables x are restricted to take a value from an associated set of discrete values which are usually integer values. These optimization problems can be formulated as a mixed integer nonlinear programming (MINLP) problem of the following form:

$$\begin{matrix}min & f ( x , y ) \\ s . t & {h}_{i} ( x , y ) = 0 , i ∈ ɛ = \{ 1 , … , {n}_{ɛ} \} \\ & {g}_{j} ( x , y ) \leq 0 , j ∈ = \{ 1 , … , \} \\ & x ∈ {R}^{n} , y ∈ {Z}^{m}\end{matrix} \qquad ( 1.2 )$$

MINLP has found a variety of important applications in science and engineering, including the electrical and biological engineering and the operations-research (OR) practice. For instance, the telecommunication network design and optimization, DNA data compression, traveling-salesman problems, resource allocation and constraint satisfaction problems, network reconfiguration in power grids and service restoration in distribution systems can all be formulated as MINLPs. However, even for linear objective and constraint functions in (1.2), the number of local optimal solutions to the optimization problem (1.2) usually grows exponentially as the number of integral variables y increases. As a result, the existence of multiple local optimal solutions, the number of which is typically unknown, to the optimization problem (1.2) is not only due to the nonlinearity and nonconvexity of the objective and constraint functions, but also due to the integral restriction over the variables y. Combined effects of these properties render solving the MINLP problem (1.2) a very difficult task and it is very challenging to find the global optimal solution to the MINLP problem (1.2). Indeed, many MINLP problems are classified as NP-hard problems.

There has been a wealth of research efforts focused on developing effective and robust methods to solve the MINLP problem (1.2). These methods include numerous deterministic schemes and intelligent techniques which have been brought forward in the past decades. In 1960 a general algorithm Branch-and-Bound (B&B) was proposed by A. H. Land and A. G. Doig for discrete optimization. Later on a more powerful hybrid method Branch-and-Cut (B&C) was proposed in the 1990's, which incorporated the cutting-plane method with B&B. In comparison with B&B, the method B&C usually returns high quality solutions with less time-consumption. This is mainly because the cutting plane component shortens the process to obtain an integer solution, and in turn a larger number of sub-problems can be discarded as fruitless candidates in an earlier stage. It has been noticed that only the upper bounds are considered in conventional B&B method. In fact, properly designed lower bounds can also be involved in the search procedure, resulting a faster shrink of the search space. To this end, another variant called Branch-and-Reduce (B&R) method was proposed by M. Tawarmalani and N. V. Sahinidis, where lower bounds were computed and updated by successive convex under-approximations of a relaxed problem for the MINLP problem (1.2).

With an aim to achieve better performance of B&B, many hybrid methods have been proposed where B&B is integrated with heuristic search algorithms, such as evolutionary algorithms, particle swarm optimization, ant colony, and simulated annealing. It is worthwhile noting that the actual effects of these methods can be both positive and negative. On one hand, these methods have advantages of wide applicability, easy-parallelization and robustness in the quality of solution. On the other hand, however, these methods can still suffer from several drawbacks; in particular, the accuracy of solutions obtained within limited time cannot be predicted and a global-optimal solution is not guaranteed.

### SUMMARY

According to one embodiment of the invention, a method generates a global optimal solution to a mixed integer nonlinear programming (MINLP) problem, where a part or all of optimization variables of the MINLP problem are restricted to have discrete values. First, relaxed continuous problems of the MINLP problem are generated. For each relaxed continuous problem that has an integer solution with an objective value superior to a current bound, the method updates the current bound with the objective value, computes a set of stable equilibrium points (SEPs) around the integer solution in a nonlinear dynamical system associated with the relaxed continuous problem, identifies from the SEPs a set of starting points for the MINLP problem, and computes a set of integer solutions to the MINLP problem with progressively tightened bounds from the starting points using an MINLP solver. The global optimal solution is generated based on the integer solutions.

In another embodiment, a system generates a global optimal solution to an MINLP problem wherein a part or all of optimization variables of the MINLP problem are restricted to have discrete values. The system comprises one or more processors and one or more memory devices coupled to the one or more processors. The one or more processors are adapted to perform operations of a global optimizer to generate relaxed continuous problems of the MINLP problem. For each relaxed continuous problem that has an integer solution with an objective value superior to a current bound, the one or more processors are adapted to update the current bound with the objective value, compute a set of stable equilibrium points (SEPs) around the integer solution in a nonlinear dynamical system associated with the relaxed continuous problem, identify from the SEPs a set of starting points for the MINLP problem, and compute a set of integer solutions to the MINLP problem with progressively tightened bounds from the starting points using an MINLP solver. The global optimal solution is generated based on the integer solutions.

In yet another embodiment, a computer readable storage medium includes instructions that, when executed by a processing system, cause the processing system to perform the aforementioned method for generating a global optimal solution to an MINLP problem wherein a part or all of optimization variables of the MINLP problem are restricted to have discrete values.

### BRIEF DESCRIPTION OF THE DRAWINGS

Embodiments are illustrated by way of example and not limitation in the Figures of the accompanying drawings:

FIG. 1 is a diagram illustrating an overall architecture of a dynamical method for solving MINLP problems according to one embodiment.

FIG. 2 illustrates a flow diagram of a dynamical method for solving MINLP problems according to one embodiment.

FIG. 3 illustrates a flow diagram of a dynamical search method for generating a comprehensive set of SEPs according to one embodiment.

FIG. 4A illustrates a diagram of the dynamical search method of FIG. 3 for finding an SEP in a dynamical system according to one embodiment.

FIG. 4B illustrates a diagram of the dynamical search method of FIG. 3 for finding another SEP in the dynamical system according to one embodiment.

FIG. 4C illustrates an example of a collection Yc of multi-tier SEPs computed by the dynamical search method of FIG. 3 according to one embodiment.

FIG. 5 is a block diagram illustrating an overall architecture of the B&B (or B&R) method for solving MINLP problems.

FIG. 6 illustrates a procedure of applying the B&B (or B&R) method for solving an example MINLP problem.

FIG. 7 is a block diagram illustrating an overall architecture of a dynamical method for solving MINLP problems incorporating the B&B (or B&R) method according to one embodiment.

FIG. 8 is a flow diagram illustrating a dynamical method for solving MINLP problems incorporating the B&B (or B&R) method according to one embodiment.

FIG. 9 illustrates a procedure of applying the dynamical method of FIG. 8 for solving an example MINLP problem according to one embodiment.

FIG. 10 is a block diagram illustrating an example of a computer system according to one embodiment.

FIG. 11 is a flow diagram illustrating a method for generating a global optimal solution to an MINLP problem according to one embodiment.

### DETAILED DESCRIPTION

Embodiments of the invention provide a systematic and dynamical method, which is deterministic in nature, for finding global optimal solutions to MINLP problems of the form (1.2). More specifically, a dynamical search method called TRUST-TECH is used to enhance the conventional MINLP solvers (also referred to as “existing MINLP solvers” or “MINLP solvers”) to achieve improved solution quality. TRUST-TECH is a method rooted in theories of nonlinear dynamical systems and characterizations of stability region and stability boundaries. TRUST-TECH can solve continuous nonlinear optimization problems in a deterministic manner. TRUST-TECH achieves the goal of optimization by first constructing a dynamical system, then carrying out a systematic and tier-by-tier search in the constructed dynamical system to compute a complete set of stable equilibrium points (SEPs), and then computing a complete set of integer solutions to the optimization problem starting from the SEPs. The dynamical system is constructed such that there is a one-to-one correspondence between the local optimal solutions to the optimization problem and the SEPs in the constructed dynamical system. The global optimal solution can be identified from the complete set of integer solutions as the specific local optimal solution with the minimum objective value.

As mentioned above, for simplicity of the description and without loss of generality, only minimization optimization problems will be described. It is understood that TRUST-TECH can be applied to both minimization and maximization optimization problems. Moreover, it is understood that an “upper bound” is computed and updated in connection with a minimization optimization problem, whereas a “lower bound” is computed and updated in connection with a maximization optimization problem. Thus, in the following description, the term “upper bound” can be replaced by the term “lower bound” when maximization optimization problems are being solved by the methods described herein. Thus, the term “bound” as used herein represents an “upper bound” for minimization and a “lower bound” for maximization. An objective value is “superior” to a current bound when the objective value is less than a current upper bound, or when the objective value is greater than a current lower bound, depending on whether a minimization or a maximization optimization problem is being solved.

TRUST-TECH is a deterministic method in that, given an initial point and a set of search directions, the final output solution will be deterministic. In other words, if TRUST-TECH is executed for multiple times (on a same machine or different machines) given the same initial point and search directions, the resulted solution will be exactly the same. It is because there is no randomness embedded in TRUST-TECH. On the contrary, existing global optimization methods, such as genetic algorithm, particle swarm optimization, evolutionary programming, simulated annealing, etc., have embedded randomness as an indispensable and critical component in their search mechanisms, and therefore, cannot guarantee such deterministicness.

According to embodiments of the invention, conventional MINLP solvers may include, but are not limited to, the Branch-and-Bound (B&B) method and its variants. Examples of the variants of B&B include, but are not limited to, the Branch-and-Reduce (B&R) method, the Branch-and-Cut (B&C) method, and other variants as understood by a person of ordinary skill in the field of nonlinear dynamical systems.

In one embodiment, an MINLP solver (e.g., the B&B method or its variant) is guided by TRUST-TECH in following manner. First, in a dynamical system associated with a relaxed problem of a given MINLP problem, a comprehensive set of multi-tier stable equilibrium points (SEPs) is computed and serves as initial points to the B&B method. A vector yₛ is called an SEP if F(yₛ)=0 and all eigenvalues of the Jacobian matrix ∇F(yₛ) have negative real parts. Any improved integer solution computed within the B&B method is promptly used to update the current upper bound for the succeeding searches. The term “improved” herein means integer solutions with better objective values, such as lower objective function values for minimization problems, or higher objective function values for maximization problems. By imposing this upper bound, as a result, most of the multi-tier SEPs will be identified as inferior and thus discarded. Therefore, the upper bound in the B&B method can be tightened very quickly and the process of approaching the global optimal solution is significantly accelerated. Numerical results on benchmark MINLP functions shows that, compared to the conventional B&B methods, the TRUST-TECH guided B&B method exhibits significant improvements on both solution quality and computational efficiency.

The TRUST-TECH guided method has the following features:

1) The TRUST-TECH guided method is a dynamical method that solves MINLP problems whose objective and/or constraint functions can be nonlinear and nonconvex.

2) TRUST-TECH can guide any existing MINLP method or solver that involves a bounding operation by implanting a dynamical search inside the existing method or solver, thus significantly accelerating the underlying search procedure of the existing method or solver.

3) The TRUST-TECH guided method described herein can compute a comprehensive set of SEPs in a dynamical system associated with the relaxed continuous problems of the MINLP problem.

4) The TRUST-TECH guided method described herein can compute the global optimal solution to the MINLP problem by progressively improving the upper bound and thus consistently improving the integer solutions.

5) The TRUST-TECH guided B&B method described herein can compute the global optimal solution to an MINLP problem by tightening the upper bound very quickly and thus rapidly and significantly improving the integer solutions.

TRUST-TECH Enhanced Methods for Mixed-Integer Nonlinear Programs. For convenience of description but without loss of generality, instead of referring to the general MINLP formulation of the form (1.2) with both continuous variables x and integer/discrete variables y, we refer to an alternative formulation of the form (2.1) with solely integer/discrete variables y. That is, solving the MINLP problem of the form (1.2) is equivalent to solving the problem of the form (2.1), without loss of generality. The problem of form (2.1) is also referred to the integer problem in the description herein, whereas the problem of the form (2.2) below is referred to as the associated relaxed continuous problem. It is noted that the term “relaxed” in the description herein refers to treating integer variables as continuous variables with integral constraints removed (i.e., the constraint is relaxed).

$$\begin{matrix}\begin{matrix}min & f ( y ) \\ s . t & {h}_{i} ( y ) = 0 , i ∈ ɛ = \{ 1 , … , {n}_{ɛ} \} \\ & {g}_{j} ( y ) \leq 0 , j ∈ = \{ 1 , … , \} \\ & x ∈ {Z}^{m}\end{matrix} & ( 2.1 ) \\ \begin{matrix}min & f ( y ) \\ s . t & {h}_{i} ( y ) = 0 , i ∈ ɛ = \{ 1 , … , {n}_{ɛ} \} \\ & {g}_{j} ( y ) \leq 0 , j ∈ = \{ 1 , … , \} \\ & y ∈ {R}^{m}\end{matrix} & ( 2.2 )\end{matrix}$$

Solving a mixed-integer nonlinear programming (MINLP) problem of the form (2.1) usually involves solving a set of relaxed continuous sub-problems of the form (2.2). Because of the nonlinearity and nonconvexity of the objective and/or constraint functions, there can be many local optimal solutions of a relaxed continuous problem of the form (2.2). One reliable way to find the global optimal solution of the continuous optimization problem (2.2) is to first find all of the local optimal solutions. From these local optimal solutions, the global optimal solution can then be found. The global optimal solution can be found by the following two conceptual steps: (i) Start from an arbitrary point and compute a local optimal solution to the optimization problem (2.2). (ii) Move away from the local optimal solution and approach another local optimal solution of the optimization problem (2.2).

TRUST-TECH guided methods realize these two conceptual steps by using trajectories of a particular class of nonlinear dynamical systems. More specifically, TRUST-TECH guided methods accomplish the task of finding the global optimal solution by the following steps:

1) Construct a dynamical system such that there is a one-to-one correspondence between the set of local optimal solutions to the optimization problem (2.2) and the set of SEPs of the dynamical system; in other words, for each local optimal solution to the problem (2.2), there is a distinct SEP of the dynamical system that corresponds to it.

2) The task of finding all local optimal solutions can be accomplished by finding all SEPs of the constructed dynamical system and finding a complete set of local optimal solutions to the problem (2.2) among the complete set of SEPs.

3) Find the global optimal solution from the complete set of local optimal solutions.

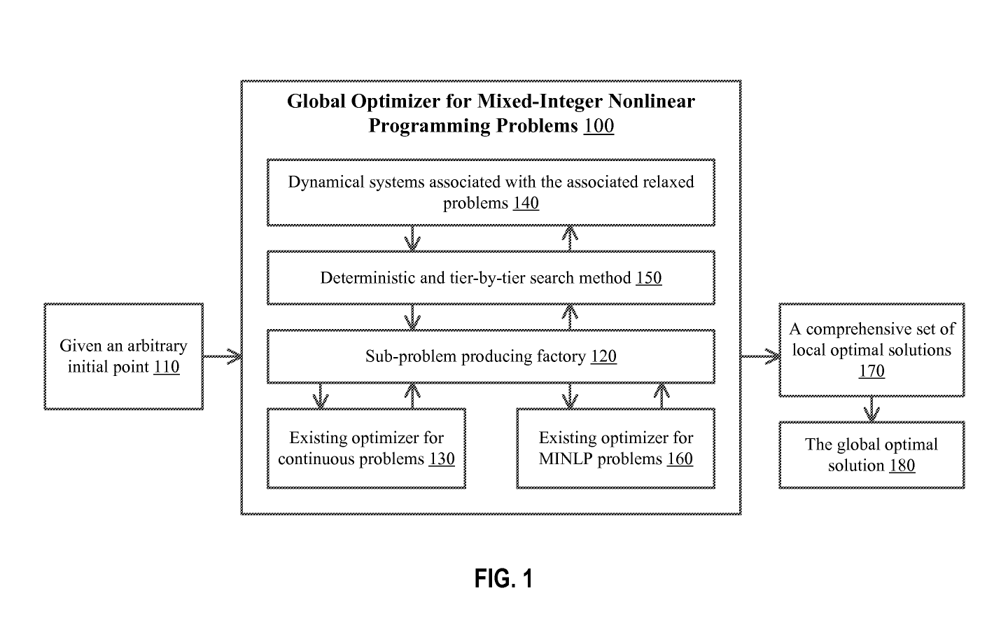

TRUST-TECH based methods are dynamical methods that can be used for solving MINLP problems to obtain a global optimal solution to the MINLP problems. FIG. 1 is a block diagram illustrating an embodiment of a global optimizer 100 for solving an MINLP problem of the form (2.1). According to FIG. 1, the global optimizer 100 can be implemented as the following conceptual procedure:

1) Given an arbitrary initial point (block 110) (the term “initial point” is also referred to as the “starting point”), generate a set of relaxed continuous problems of the MINLP problem (2.1) using a sub-problem producing factory (block 120).

2) Apply an existing local continuous solver or optimizer (block 130) to compute a set of feasible solutions to the relaxed continuous problems and, from the computed set of feasible solutions, select a set of superior feasible solutions to the relaxed continuous problems.

3) Construct a dynamical system associated with the relaxed continuous problem (2.2) of the MINLP problem (2.1) (block 140), and perform a deterministic, tier-by-tier dynamical search method (block 150) by incorporating the existing local continuous optimizer (block 130) to compute a comprehensive set of SEPs around each superior feasible solution in the dynamical system. Identify a set of superior SEPs from the comprehensive set of SEPs.

4) Use the set of superior SEPs as initial points, and apply an existing MINLP solver (block 160) to compute a set of integer solutions to the MINLP problem (2.1). Identify from the set of integer solutions a set of improved integer solutions (block 170).

6) Compute an updated set of relaxed continuous problems if necessary.

7) Identify the global optimal solution to the MINLP problem (2.1) from the set of integer solutions (block 180).

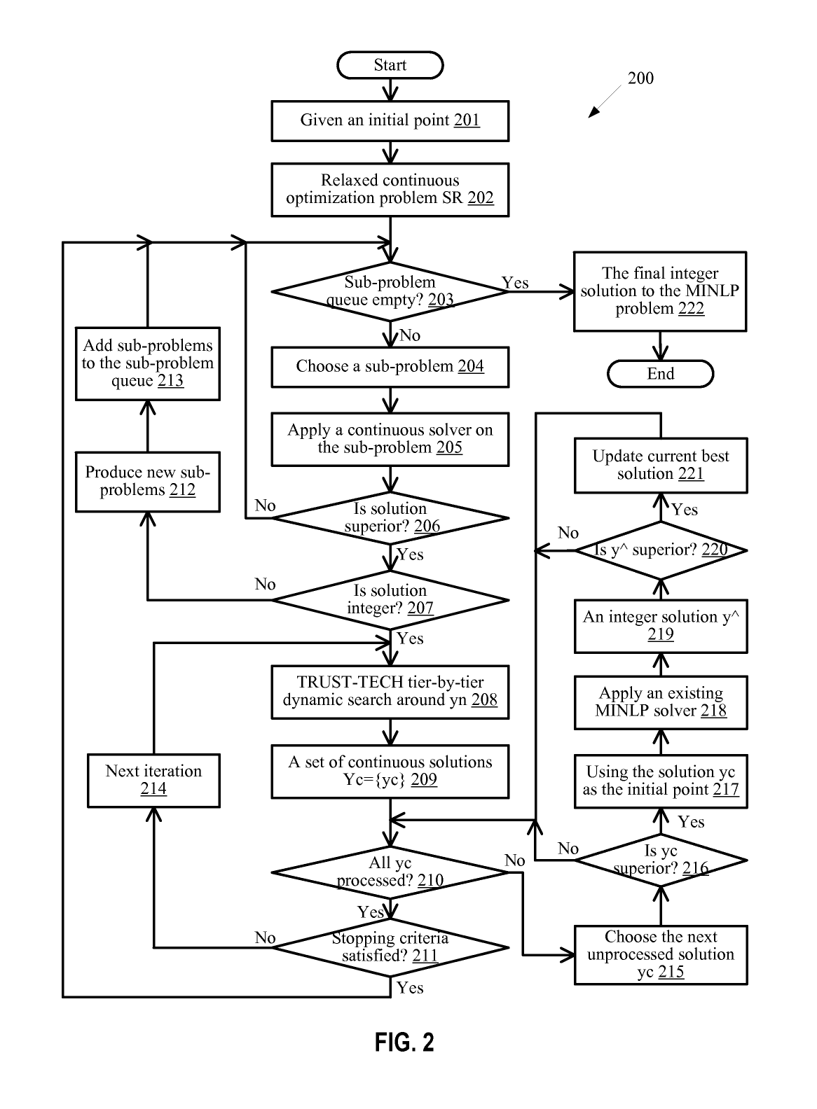

FIG. 2 is a flow diagram illustrating one embodiment of a dynamical method 200 for obtaining a global optimal solution to the MINLP problem (2.1). The method 200 can be executed by software, hardware, firmware, or a combination thereof. In one embodiment, the method 200 is executed by a processing system such as a computer system. According to FIG. 2, in one embodiment, the method 200 begins with a given arbitrary initial point at step 201. The method proceeds to format the relaxed continuous optimization problem SR of the MINLP problem and initialize a stack (i.e., a queue) of relaxed continuous problems (i.e., the sub-problems) at step 202. It is determined whether or not the relaxed continuous problem stack is empty at step 203. If the stack is empty, then the method proceeds to step 222; otherwise, the method proceeds to step 204.

At step 204, the method proceeds to select a relaxed continuous problem from the stack and remove it from the stack. At step 205, the method proceeds to apply a continuous solver to solve the relaxed continuous problem and compute a feasible solution to the relaxed continuous problem. Examples of the continuous solvers include, but are not limited to: the interior point method (IPM), the sequential quadratic programming (SQP), the augmented Lagrangian method, etc.

It is determined at step 206 whether or not the solution is superior; e.g., whether the solution has an objective value lower than the current upper bound. If the solution is superior when compared with the current best solution, then the method proceeds to step 207; otherwise, the method returns to step 203. At step 207, it is determined whether or not the solution is integer. If the solution is integer, then the method proceeds to step 208; otherwise, the method proceeds to step 212.

At step 208, the TRUST-TECH tier-by-tier dynamical search is performed to compute, at step 209, a set of multi-tier SEPs (i.e., Yc) around the current best solution point yn. This set of SEPs is a set of neighboring local optimal solutions of the relaxed continuous problem. The set of multi-tier SEPs include an innermost SEP surrounded by tiers of SEPs; e.g., a set of first-tier SEPs that are surrounded by a set of second-tier SEPs. It is understood that the collection Yc may contain any number of tiers of SEPs surrounding an innermost SEP. In some embodiments, the collection Yc may omit some of the SEPs surrounding the innermost SEP with no or negligible degradation to the final global optimal solution.

It is determined at step 210 whether or not the set of SEPs (i.e., Yc) is empty; that is, whether all of the SEPs in Yc have been processed. If Yc is empty, then it is determined at step 211 whether or not predetermined stopping criteria are satisfied; e.g., whether the maximum number of iterations has been reached or the solution has converged. If the stopping criteria are satisfied, the method returns to step 203; otherwise, the method proceeds to step 214 to start the next iteration of the TRUST-TECH tier-by-tier dynamical search.

If at step 210 it is determined that not all of the SEPs in Yc have been processed, the method proceeds to step 215 to choose a next unprocessed SEP; e.g., the y_{c} that has the minimum objective value in Yc can be chosen; or the y_{c} that was added to Yc before all the remaining points in Yc can be chosen. The chosen y_{c} is then removed from Yc. At step 216, it is determined whether the chosen SEP is superior; that is, whether the chosen SEP is better than the current best solution (e.g., the chosen SEP has an objective value lower than a current upper bound). If the chosen SEP is superior, the method proceeds to step 217; otherwise, the method returns to step 210.

The method proceeds to use the SEP as an initial point at step 217, and apply an existing MINLP solver at step 218 to obtain an integer solution ŷ at step 219. It is then determined at step 220 whether or not ŷ is a superior solution (e.g., its objective value is lower than a current upper bound); if it is, the method proceeds to step 221; otherwise, the method returns to step 210. At step 221, the method proceeds to update the current best solution with the new superior solution.

At step 212 (i.e., when the solution of step 207 is non-integer), the method proceeds to produce new relaxed continuous problems at the feasible solution obtained for the parent relaxed continuous problem. At step 213, the method proceeds to add the newly produced relaxed continuous problems to the stack and continue to step 203, until all of the sub-problems in the stack are processed. At step 222, the entire search procedure terminates and the method produces the final integer solution to the MINLP problem.

The TRUST-TECH Dynamical Search Method. The TRUST-TECH dynamical search method plays an important role in the dynamical method described herein for solving the MINLP problem (2.1). During the solution procedure of the dynamical method, TRUST-TECH is used to compute a complete set of SEPs in a dynamical system associated with the relaxed continuous problem (2.2).

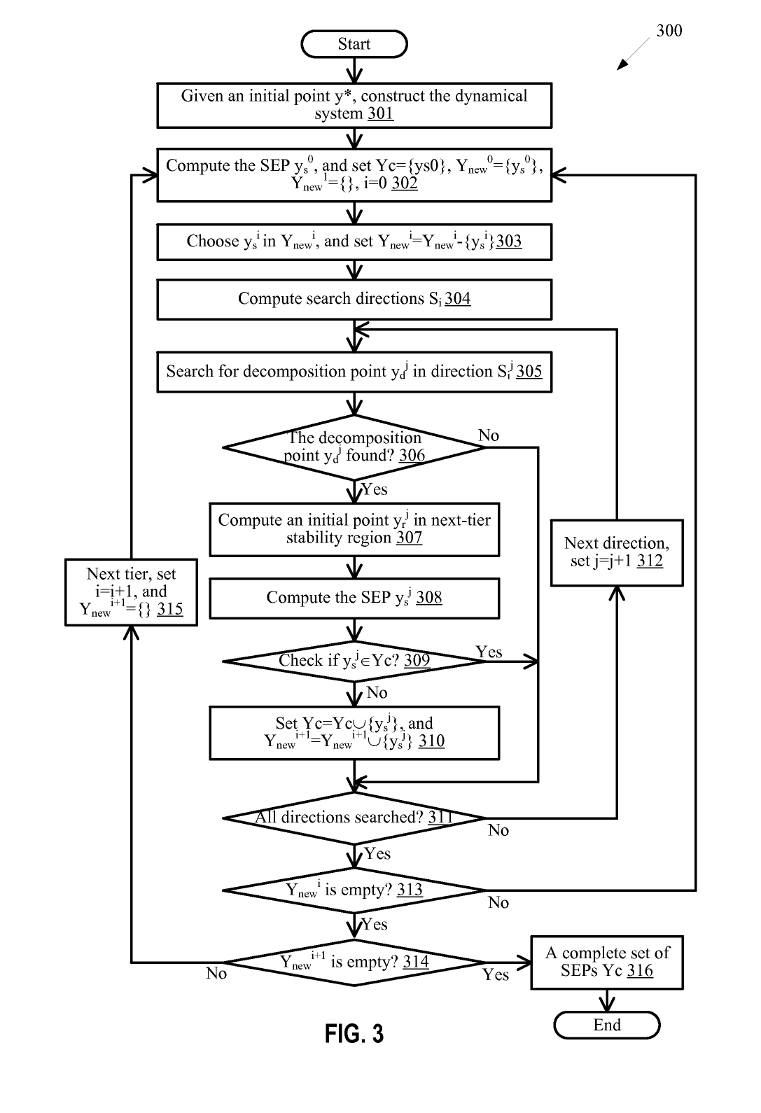

FIG. 3 is a flow diagram illustrating an embodiment of the TRUST-TECH dynamical search method 300. The method 300 can be executed by software, hardware, firmware, or a combination thereof. In one embodiment, the method 300 is executed by a processing system such as a computer system. According to FIG. 3, in one embodiment, a computer system begins executing the method 300, with a given an initial point y*, by constructing a dynamical system (301) associated with the relaxed continuous problem (4.2). The nonlinear dynamical system is constructed such that each local optimal solution to the relaxed continuous problem corresponds to a distinct SEP of the nonlinear dynamical system. At step 302, the method proceeds to apply a local continuous solver using the initial point y* to compute an initial SEP yₛ⁰ of the dynamical system, and set i=0, Y_{c}={yₛ⁰}, Y_{new}ⁱ={yₛ⁰}, and Y_{new}ⁱ⁺¹=Ø (i.e., empty set { }). At step 303, the method proceeds to choose yₛⁱ in Y_{new}ⁱ, and set Y_{new}ⁱ=Y_{new}ⁱ−{yₛⁱ}. For each SEP in Y_{new}ⁱ, the method proceeds to steps 304-312 as follows.

At step 304, the method proceeds to compute a set of search directions {Sᵢ^{j},j=1, 2, . . . , mᵢ}, and sets j=1. At step 305, the method proceeds to search a decomposition point y_{d}^{j} along the search direction Sᵢ^{j}. A decomposition point is a type-1 unstable equilibrium point (i.e., the Jacobian matrix of the dynamical system has only one eigenvalue with a positive real part). Its unstable manifold is a one-dimensional trajectory and converges to a pair of neighboring stable equilibrium points. If a decomposition point y_{d}^{j} is found at step 306, the method proceeds to step 307; otherwise, the method proceeds to step 311.

At step 307, the method proceeds to set y₀^{j}=y_{d}^{j}+ε(y_{d}^{j}−yₛⁱ), where ε is a small number, and compute a new initial point yᵣ^{j}, which is in a next-tier stability region, by integrating the trajectory of the dynamical system for a number of steps starting from y₀^{j}.

At step 308, the method proceeds to apply the local optimizer using the initial point yᵣ^{j} to compute an SEP yₛ^{j}. At step 309, it is determined whether yₛ^{j}εY_{c}, and if yₛ^{j}εY_{c}, the method proceeds to step 311; otherwise, the method proceeds to step 310 to set Y_{c}=Y_{c}∪{yₛ^{j}} and Y_{new}ⁱ⁺¹=Y_{new}ⁱ⁺¹∪{yₛ^{j}} and then continues to step 311.

At step 311, the method proceeds to determine whether all directions have been searched by setting j=j+1 and checking whether j<=mᵢ. If j<=mᵢ (that is, not all of the directions have been searched), the method proceeds to step 312 and then step 305 to search the next direction; otherwise, the method proceeds to step 313.

At step 313, it is determined whether Y_{new}ⁱ is non-empty. If Y_{new}ⁱ is non-empty, then the method proceeds to step 303 to search from a new yₛⁱ. Otherwise, the method proceeds to step 314.

At step 314, it is determined whether Y_{new}ⁱ⁺¹ is non-empty. If Y_{new}ⁱ⁺¹ is non-empty, then the method proceeds to set i=i+1 at step 315 and then to step 303 to search the directions in the next tier (i.e., the next outer tier). Otherwise, the method proceeds to step 316. At step 316, the method proceeds to output the complete set of SEPs (i.e., Yc) of the dynamical system.

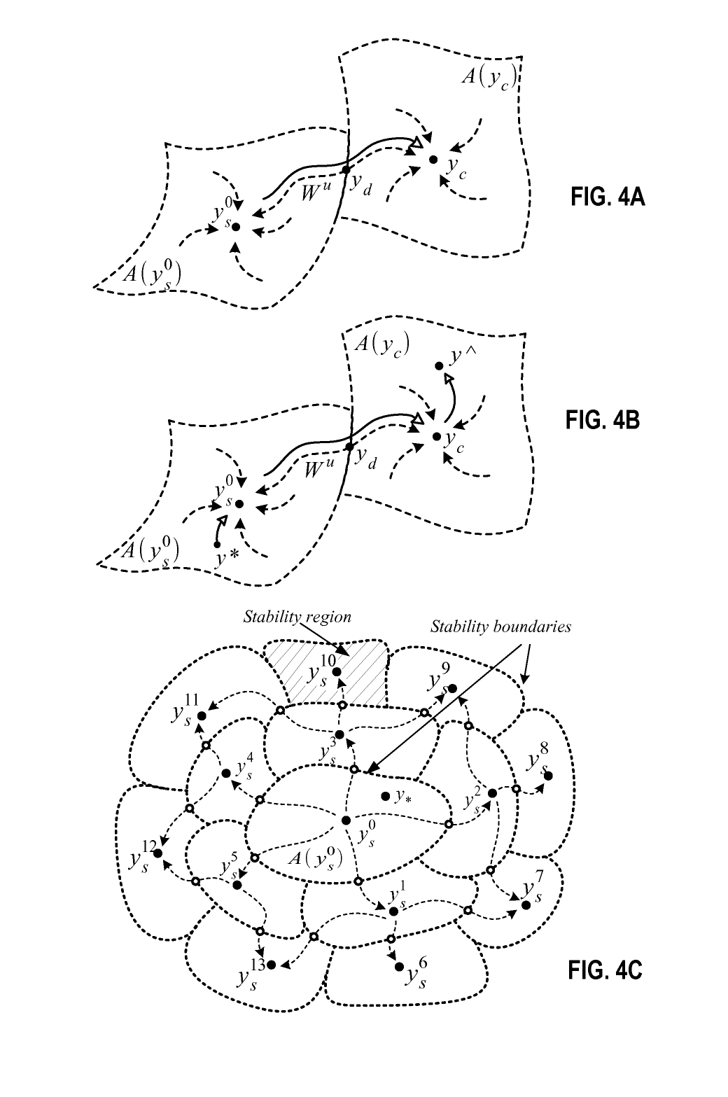

It has been found that existing MINLP solvers can effectively solve convex MINLP problems or non-convex MINLP problems whose optimal solution is restricted to a stability region in a dynamical system associated with the relaxed problem. Therefore, TRUST-TECH can be used to incorporate the existing MINLP solvers, using its ability to compute a comprehensive set of SEPs in a dynamical system. Referring to the example of FIG. 4A and FIG. 4B, such incorporation can be realized by first constructing a dynamical system associated with the relaxed problem of the MINLP problem (FIG. 4A), and then finding a set of multi-tier SEPs around a feasible solution to the MINLP problem obtained by the MINLP solver. Subsequently, starting from these SEPs, a set of new feasible solutions to the MINLP problem is found using the MINLP solver (FIG. 4B). In the example of FIG. 4A and FIG. 4B, A(y_{c}) represents the stability region of the SEP y_{c}, and A(yₛ₀) represents the stability region of the SEP yₛ₀. Moreover, y_{d} represents a decomposition point mentioned above in FIG. 3, W^{u} represents the unstable manifold of an equilibrium point (which is y_{d} in this context), y_{c} represents a tier-1 SEP obtained by TRUST-TECH, y* represents an initial point, which is an integer solution obtained by an existing MINLP solver. Finally, ŷ represents a new integer solution obtained by the existing MINLP solver, using yc as the initial point.

FIG. 4C illustrates an example of a collection Yc={yₛⁿ, n=0, 1, . . . , 13} of multi-tier SEPs, as computed by the TRUST-TECH dynamical search method. The innermost SEP yₛ⁰ is surrounded by tiers of SEPs; e.g., the first-tier SEPs: yₛ¹, yₛ², yₛ³, yₛ⁴, yₛ⁵, and the second-tier SEPs: yₛ⁶, yₛ⁷, yₛ⁸, yₛ⁹, yₛ¹⁰, yₛ¹¹, yₛ¹², yₛ¹³. Each SEP is contained in a stability region defined by a stability boundary (shown in FIG. 4 as dotted lines). For example, the SEP yₛ¹⁰ is contained in a stability region shown in hatched lines, and A(yₛ₀) represents the stability region of the SEP yₛ₀. Like the SEPs, the stability regions are tiered. Although two tiers of SEPs are shown in the example of FIG. 4C, it is understood that the collection Yc may contain any number of tiers of SEPs surrounding the innermost SEP.

As described above, the conventional MINLP solvers that can be incorporated by TRUST-TECH include the B&B method and its variants. B&B is a widely-used method for solving linear and nonlinear mixed integer programming (MIP) problems. B&B has been the prevailing method among the existing MINLP solvers for decades. B&B adopts the divide-and-conquer concept and systematically divides the given problem into a collection of easy sub-problems. By taking advantage of the solutions of sub-problems, the lower and/or upper bounds are progressively updated, which are crucial in determining which sub-problems to be discarded or to be remained for further branching. In this way, the computing burden for the whole solution procedure is alleviated.

The following description provides the details of the B&B related methods. The “B&B related method” herein refers to the B&B method or one of its variants (e.g., the B&R method or the B&C method). The B&B related method is one example of the existing MINLP solver. Before describing the TRUST-TECH enhanced B&B related methods, it is helpful to explain the computations of the B&B related method. In the following, the algorithms for the B&B method and the B&R method are provided.

The Branch-and-Bound (B&B) Method. For convenience, the integer problem (21) and the relaxed continuous problem (2.2) are denoted by SI and SR, respectively. The problem (2.1) can be solved by B&B. The following Algorithm 1 presents an algorithm of the B&B method.

Algorithm 1: The Branch-and-Bound (B&B) Method

Input: the relaxed continuous problem SR, the initial upper bound Bu*

Output: the best discovered solution (i.e., the solution having the minimum object function values).

Algorithm:

Step 1) Initialize the list of unsolved sub-problems: L←{SR}, the incumbent integer solution y*←Ø, and the current upper bound Bu←Bu*.

Step 2) Select a sub-problem S from L, and compute a feasible solution y of S by using a local solver.

Step 3) Apply a bounding operation to prune the search; that is, the solution value f(y) is compared with the current upper bound Bu. If f(y)<Bu, then go to Step 4; otherwise, go to Step 7.

Step 4) Determine whether the variable y is integral; that is, whether y=(y₁, . . . , yₙ)εZⁿ. If y is integral, then proceed to Step 5; otherwise, proceed to Step 6.

Step 5) Set y*=y and Bu=f(y), which is a tightened bound, and go to Step 7.

Step 6) Find a fractional coordinate yₖ′ of y, and set S₁=S∩{y,yₖ′≧┌yₖ′┐}, S₂=S∩{y,yₖ′≦└yₖ′┘}, and L=L∪{S₁,S₂}. Then, proceed to Step 7.

Step 7) If L≠Ø, then go to Step 2; otherwise, stop the search procedure and output the best discovered solution y*.

The B&B method is an algorithm employing implicit enumeration scheme which evaluates only a small portion of all the possible solutions and discards other useless solutions by a pruning operation. The B&B method uses a branching operation to generate mutually-exclusive relaxed continuous problems. However, the collection of unsolved relaxed continuous problems may keep growing and become computationally intractable in a limited amount of time, especially for problems of highly-nonlinear and nonconvex objective and/or constraint functions. In this regard, B&B may return a solution far away from the global optimal solution, which is also a common disadvantage shared by heuristic algorithms. Therefore, there is a need for methods that not only can take advantage of the features of B&B related methods but also can improve their solution quality.

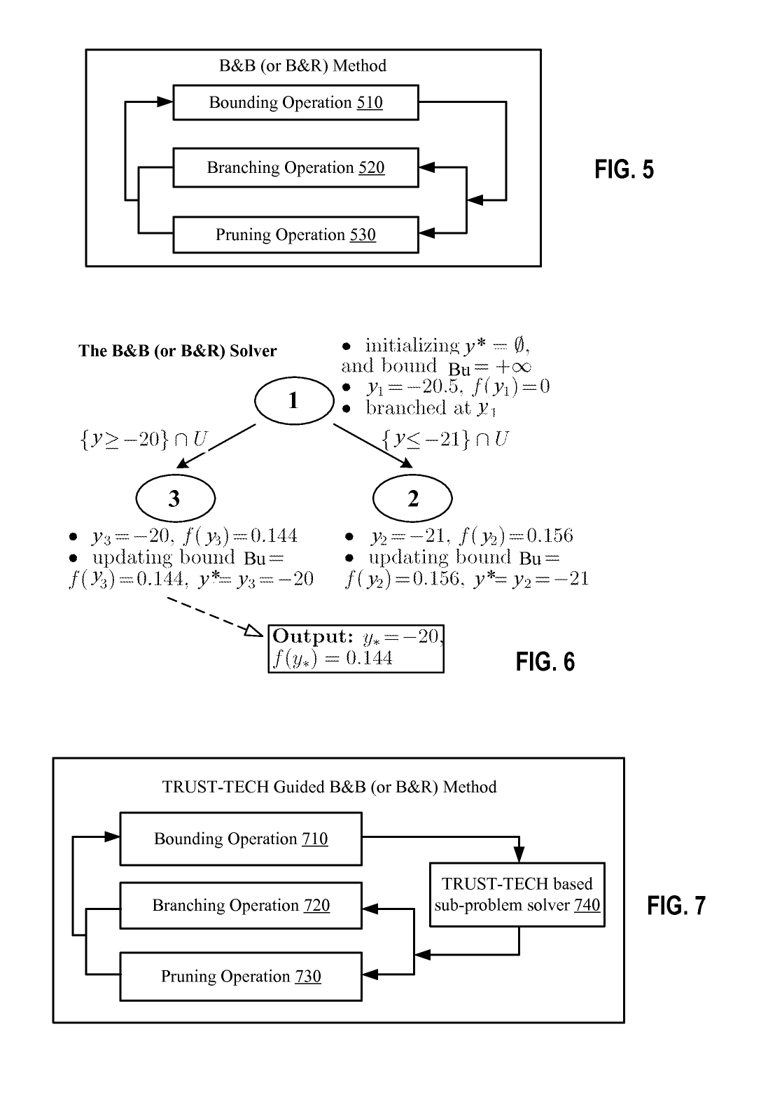

FIG. 5 is a block diagram illustrating three major components of the B&B method. One component is a bounding operation 510, which computes the lower and/or upper bounds that play the central role in controlling the search process. Another component is a branching operation 520, which produces new candidate relaxed continuous problems from intermediate solutions to the relaxed continuous problems of the MINLP problem. A further component is a pruning operation 530, which determines which candidate relaxed continuous problems and intermediate solution to be retained for further analysis, and which relaxed continuous problems and intermediate solutions to be discarded to trim down the search space. The components 510, 520 and 530 are inter-connected in a loop structure with proper stopping criteria, realizing an iterative procedure for finding solutions to the MINLP problems.

FIG. 6 illustrates a procedure for solving an integer program (2.3) using the B&B method of FIG. 5. The integer program (2.3) in this example is:

$$\begin{matrix}min & f ( y ) = \frac{1}{1000} {( y + 20.5 )}^{2} ( y - 3 ) ( y - 5 ) \\ subject to \text{:} & y ∈ \{ - 30 , - 29 , … , 0 , … , 29 , 30 \}\end{matrix} \qquad ( 2.3 )$$

with an associated relaxed continuous problem (2.4):

$$\begin{matrix}min & f ( y ) = \frac{1}{1000} {( y + 20.5 )}^{2} ( y - 3 ) ( y - 5 ) \\ subject to \text{:} & - 30 \leq y \leq 30\end{matrix} \qquad ( 2.4 )$$

The procedure can be carried out using the B&B method of FIG. 5 in the following steps.

Step 1) Initialize y*=Ø and the upper bound Bᵤ=+∞, and set the initial relaxed continuous problem #1 (represented by the top circle) to be the relaxed continuous problem (2.4).

Step 2) Given the initial point y₁=−20.5 and f(y₁)=0, apply the branching operation at yᵢ and two relaxed continuous problems, one of which is the relaxed continuous problem #2 (represented by the lower right circle) of the form (2.4) with −30≦y≦−21, and the other is the relaxed continuous problem #3 (represented by the lower left circle) with −20≦y≦30.

Step 3) Solve the relaxed continuous problem #2 to obtain the solution y_{z}=−21 and f(y2)=0.156, and update the upper bound to be Bᵤ=f(y2)=0.156 and y*=y₂=−21.

Step 4) Solve the relaxed continuous problem #3 to obtain the solution y₃=−20 and f(y3)=0.144, and update the upper bound to be Bᵤ=f(y3)=0.144 and y*=y₃=−20.

Step 5) Output the final solution y*=−20 and f(y*)=0.144.

The Branch-and-Reduce (B&R) Method. The B&R method is a variant of B&B for solving linear and nonlinear MINLP problems. Similar to the B&B method, B&R also adopts the divide-and-conquer concept and systematically divides the given problem into a collection of easy sub-problems. By taking advantage of the solutions of sub-problems, the lower and upper bounds are progressively updated, which are crucial in determining which sub-problems to be discarded or to be remained for further branching. In this way, the computing burden for the whole solution procedure is alleviated.

For convenience, the integer program (2.1) and the relaxed continuous problem (2.2) are denoted by SI and SR, respectively. The problem (2.1) can be solved by B&R. The following Algorithm 2 presents a procedure of the B&R method.

Algorithm 2: The Branch-and-Reduce Method

Input: the relaxed continuous problem SR, the initial upper bound Bu*

Output: best discovered solution (i.e., the solution having the minimum object function values).

Algorithm:

Step 1) Initialize the list of unsolved sub-problems: L←{SR}, the incumbent integer solution y*←Ø, and the current upper bound Bu←Bu*.

Step 2) Select a sub-problem S from L, and compute a feasible solution y of S by using a local continuous solver (also referred to as “local optimizer” or “local solver”). Examples of local solvers include, but are not limited to: the interior point method (IPM), the sequential quadratic programming (SQP), the augmented Lagrangian method, etc.

Step 3) Apply a lower bounding operation to produce a linear under-approximation of the sub-problem S and proceed to Step 4.

Step 4) Determine whether the variable y is integral; that is, whether y=(y₁, . . . , yₙ)εZⁿ. If y is integral, then proceed to Step 5; otherwise, proceed to Step 6.

Step 5) Determine whether the objective function is improved; that is, whether f(y)<f(y*). If f(y)<f(y*), set y*=y and Bu=f(y), which is a tightened bound, and proceed to Step 6; otherwise go to Step 10.

Step 6) Apply the upper bounding operation to prune the search; that is, the solution value f(y) is compared with the current upper bound Bu. If f(y)<Bu, then go to Step 7; otherwise, go to Step 10.

Step 7) Determine whether the variable y is integral; that is, whether y=(y₁, . . . , yₙ)εZⁿ. If y is integral, then proceed to Step 8; otherwise, proceed to Step 9.

Step 8) Set y*=y and Bu=f(y), which is a tightened bound, and go to Step 10.

Step 9) Find a fractional coordinate yk′ of y, and set S₁=S∩{y,yₖ′≧┌yₖ′┐}, S₂=S∩{y,yₖ′≦└yₖ′┘}, and L=L∪{S₂,S₂}. Then, proceed to Step 10.

Step 10) If L≠Ø, then go to Step 2; otherwise, stop the search procedure and output the best discovered solution y*.

The TRUST-TECH Guided Branch-and-Bound Method. In an embodiment of the dynamical method for solving MINLP problems, the B&B method is used as the existing MINLP solver to be guided by TRUST-TECH. It is understood that other existing MINLP solvers may also be used. TRUST-TECH plays the role of commander and directs the B&B to carry out an extensive search. Compared to the B&B, the TRUST-TECH guided B&B method finds distinct and improved integer solutions within limited time to thereby attain the global optimal solution to MINLP problems.

Different strategies are available when adopting TRUST-TECH into B&B related methods. TRUST-TECH can be successfully applied to improve the local solvers for continuous optimization problems. Hence, one consideration in adopting TRUST-TECH in B&B related methods is to implement and invoke the TRUST-TECH search procedure to guide the local solver at step 7 of Algorithm 1. Such an implementation will generally result in better solutions to the relaxed continuous problem S. Nevertheless, it has been realized that the optimal integer solution of the integer problem SI (2.1) usually neither coincides with local optimal solutions to the associated relaxed problem SR nor coincides with the optimal solution to the relaxed continuous problem S. Indeed, the global optimal integer solution to the MINLP problem (2.1) can be far away from the global optimal solution to the corresponding relaxed continuous problems. Numerical simulations also indicate that the solution quality improvement introduced by TRUST-TECH of the continuous local solver in B&B makes little difference to the final integer solution. Conversely, such an implementation will result in increased computing-time than the B&B method requires

It has been found that the B&B method can effectively solve convex MINLP problems or non-convex MINLP problems whose optimal solution is restricted to a stability region in the associated dynamical system. This advantage of the B&B method is enhanced when the B&B method is guided to search different stability regions. A tight integration of the TRUST-TECH and B&B improves not only the solution quality but also the computational efficiency. Indeed, the B&B search procedure involves solving a series of relaxed continuous problems which are instances of the relaxed continuous problem of the form (2.2). These relaxed continuous problems are solved to obtain/update the upper bound value, which plays the central role in controlling the search process, and to produce new relaxed continuous problems. Therefore, instead of using TRUST-TECH outside the B&B search procedure as an independent procedure, TRUST-TECH can be used inside the B&B search procedure to effectively compute a comprehensive set of local optimal solutions to the involved relaxed continuous problems. In this manner, tighter upper bounds can be attained at the early stage of the B&B search procedure. As a result, the whole search procedure will be significantly accelerated, enabling a much more rapid and effective computation process for generating the global optimal solution to the MINLP problem. This motivated the development of the TRUST-TECH guided B&B method described herein for computing the global optimal solution to MINLP problems.

Referring to FIG. 7, the TRUST-TECH guided B&B method includes four major components according to one embodiment. One component is a bounding operation 710, which computes the lower and/or upper bounds that play the central role in controlling the search process. Another component is a branching operation 720, which produces new candidate relaxed continuous problems from intermediate solutions to the relaxed continuous problems of the MINLP problem. A further component is a pruning operation 730, which determines which candidate relaxed continuous problems and intermediate solution to be retained for further analysis, and which relaxed continuous problems and intermediate solutions to be discarded to trim down the search space. A further component is a TRUST-TECH based sub-problem solver 740, which finds a set of superior starting points for each relaxed continuous problem to accelerate the search of tightened upper bounds. The components 710, 720, 730 and 740 are inter-connected in a loop structure with proper stopping criteria, realizing an iterative procedure for finding solutions to the MINLP problems.

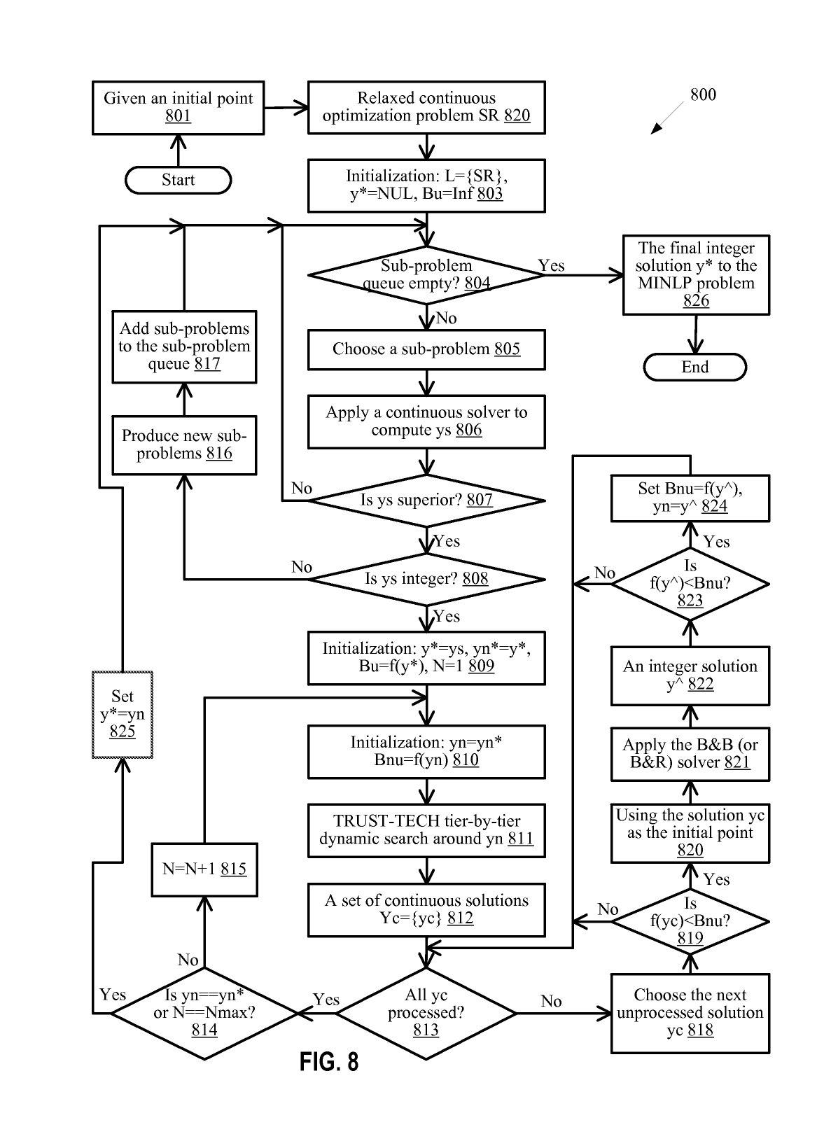

FIG. 8 is a flow diagram illustrating one embodiment of a dynamical method 800 for obtaining a global optimal solution to the MINLP problem (2.1). The method 800 can be executed by software, hardware, firmware, or a combination thereof. In one embodiment, the method 800 is executed by a processing system such as a computer system. According to FIG. 8, in one embodiment, the method 800 begins with a given arbitrary initial point y₀ at step 801. The method proceeds to format the relaxed continuous problem SR of the MINLP problem at step 802. At step 803, the method proceeds to initialize the stack (i.e., the sub-problem queue) of relaxed continuous problems L={SR}, the current best solution y*=Ø, and the current upper bound Bu=+∞ (i.e., Inf). It is then determined whether or not the relaxed continuous problem stack is empty at step 804. If the stack is empty, then the method proceeds to step 826; otherwise, the method proceeds to step 805.

At step 805, the method proceeds to select a relaxed continuous problem S from the stack L, and remove it from the stack (i.e., L=L\{S}). At step 806, the method proceeds to apply a continuous solver to solve the relaxed continuous problem S and compute a feasible solution yₛ to the relaxed continuous problem S. It is then determined at step 807 whether or not the solution yₛ is superior; that is, whether or not f(yₛ)<Bu. If yₛ is superior, then the method proceeds to step 808; otherwise, the method returns to step 804.

At step 808, it is determined whether or not the solution yₛ is integer; that is, whether or not yₛ=(yₛ₁, . . . , yₛₙ)εZⁿ. It yₛ is integer, then the method proceeds to step 809; otherwise, proceed to step 816.

At step 809, the method proceeds to update the current best solution by setting y*=yₛ, and update the current upper bound by setting Bu=f(y*). The method proceeds to initialize the inner loop, including setting the iteration counter N=1 and yn*=y*.

The method proceeds to step 810 to set yn=yn*, Bnu=f(yn*), and carry out TRUST-TECH tier-by-tier dynamical search at step 811 to compute a set of multi-tier SEPs Yc={y_{c}} around the point yn at step 812. It is then determined at step 813 whether or not the SEPs array Yc is empty (i.e., whether or not all y_{c} have been processed). If Yc is empty and stopping criteria are satisfied at step 814 (e.g., whether or not the inner-loop best solution changed: yn==yn*, and whether or not the maximum number of iterations is reached: N Nmax), then the method proceeds to set y*=yn at step 825 and returns to step 804. If Yc is empty but the stopping criteria are not satisfied at step 814, then the iteration counter is incremented by one at step 815 and the method returns to step 810. If Yc is not empty, the method proceeds to step 818.

At step 818, the method proceeds to choose the best point y_{c} in the SEP array Yc; that is, the y_{c} that has the minimum objective value, and remove y_{c} from Yc; that is, y_{c}=min{Yc} and Yc=Yc\{y_{c}}. It is then determined at step 819 whether or not the SEP point y_{c} is superior; that is, whether or not f(y_{c})<Bnu. If yc is superior, then the method proceeds to step 820; otherwise, the method returns to step 813. The method proceeds step 820 to use the point y_{c} as the initial point and apply the B&B method described above at step 821. The B&B method produces an integer solution ŷ at step 822. It is then determined at step 823 whether or not the B&B method produces a superior solution ŷ; that is, whether or not f(ŷ)<Bnu. If the B&B method produces a superior solution ŷ, then the method proceeds to step 824; otherwise, the method returns to step 813.

At step 824, the method proceeds to update the inner loop-best solution by setting yn=ŷ, and update the inner-loop upper bound by setting Bnu=f(ŷ), the method then returns to step 813. When all yc are processed and the stopping criteria of step 814 are satisfied, the method returns to step 204.

At step 808, if the solution ys is non-integer, the method proceeds to step 816 to subdivide the coordinate at yₛₖ, which is an integer point immediately adjacent to the non-integer solution to yₛ, and produce new relaxed continuous problems S₁=S∩{y,yₖ′≧┌yₛₖ┐}, and S₂=S∩{y,yₖ≦└yₛₖ┘}, where each subdivided range corresponds to a new relaxed continuous problem. The method then proceeds to step 817 to add the newly produced relaxed continuous problems to the stack L by setting L=L∪{S₁,S₂}, and return to step 804. If the sub-problem queue is empty at step 804, then the entire search procedure terminates and the method outputs the final integer solution y* at step 826.

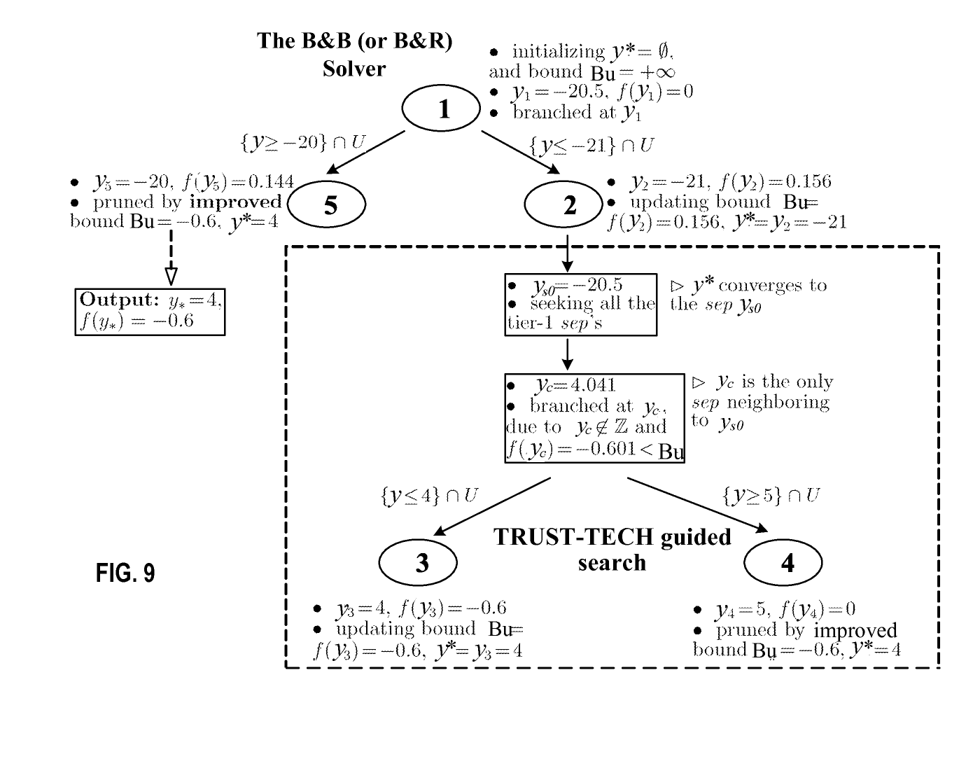

FIG. 9 illustrates a procedure for solving the example integer program (2.3) with a relaxed continuous problem (2.4) using the TRUST-TECH guided B&B method according to one embodiment. The procedure in this example include the following steps:

Step 1) Initialize y*=Ø, the upper bound Bu=+∞, and the initial relaxed continuous problem #1 to be the relaxed continuous problem (2.4).

Step 2) Given the initial point y₁=−20.5 and f(y₁)=0, apply the branching operation to y₁ and two relaxed continuous problems, one of which is the relaxed continuous problem #2 of the form (2.4) with −30≦y≦−21, and the other is the relaxed continuous problem #5 with −20≦y≦30.

Step 3) Solve the relaxed continuous problem #2 to obtain the solution y_{z}=−21 and f(y₂)=0.156, and update the upper bound to be Bu=f(y₂)=0.156 and y*=y₂=−21.

Step 4) Compute the neighboring SEP y_{c}=4.041 using TRUST-TECH and branching at y_{c}=4.041 (since y_{c} is not an integer and f(y_{c})=−0.601<Bu) to produce two relaxed continuous problems, one of which is the relaxed continuous problem #3 of the form (2.4) with −30≦y≦4, and the other is the relaxed continuous problem #4 with 5≦y≦30.

Step 5) Solve the relaxed continuous problem #3 to obtain the solution y₃=4 and f(y₃)=−0.6, and update the upper bound to be Bu=f(y₃)=−0.6 and y*=y₃=4.

Step 6) The feasible solution y₄=5 of the relaxed continuous problem #4 is pruned since f(y₄)=0>Bu=−0.6.

Step 7) The feasible solution y₅=−20 of the relaxed continuous problem #5 is pruned since f(y₅)=0.144>B_{π}=−0.6.

Step 8) Output the global optimal solution y*=4 and f(y*)=−0.6.

Although the B&B method is described above in connection with FIG. 8 and FIG. 9, it is understood that B&B variants (e.g., the B&R method) and other existing MINLP methods can also be guided by TRUST-TECH for solving MINLP problems. The TRUST-TECH guided methods have a general applicability and are not confined to work with only the B&B and B&R methods. For example, a TRUST-TECH guided Branch-and-Cut (B&C) method can be developed where the TRUST-TECH is used to guide the search of the B&C method to approach the global optimal solution in a more efficient and reliable way.

Numerical Examples. We examine the performance of the TRUST-TECH guided B&B method for global optimization of benchmark MINLP problems with non-convex objective functions. These benchmark functions are all non-negative over the real space Rⁿ and have a global minimum 0 in Zⁿ. When implementing the TRUST-TECH guided B&B method in the following examples, we have fixed the maximum number of iterations Nmax=3. Moreover, to avoid an endless search by the conventional B&B method (also referred to as the “B&B method”), an upper limit 600n, where n is the dimension of the problem, is assigned to the number of relaxed continuous problems to be solved, and the search is forced to be terminated if this limit is reached. Performance of the TRUST-TECH guided B&B method is compared with that of the B&B method. In the numerical simulations, the B&B and TRUST-TECH guided B&B have been applied to solve the pure integer programming problems, including the following objective functions of different dimensions (represented by the value of n):

Rosenbrock function:

$$\begin{matrix}min & f ( y ) = {\sum }_{i = 1}^{n - 1} ( {( {y}_{i} - 1 )}^{2} + 100 \cdot {( {y}_{i + 1} - {y}_{i}^{2} )}^{2} ) \\ subject to & y = ( {y}_{1} , … , {y}_{n} ) ∈ {Z}^{n}\end{matrix} \qquad ( 2.5 )$$

Griewank function:

$$\begin{matrix}min & f ( y ) = \frac{1}{4000} {\sum }_{i = 1}^{n} ( {y}_{i}^{2} + ( 1 - {\prod }_{i = 1}^{n} cos ( \frac{{y}_{i}}{\sqrt{i}} ) ) ) \\ subject to & y = ( {y}_{1} , … , {y}_{n} ) ∈ {Z}^{n}\end{matrix} \qquad ( 2.6 )$$

Rastrigin function:

$$\begin{matrix}min & f ( y ) = {\sum }_{i = 1}^{n - 1} ( {y}_{i}^{2} + 10 \cdot {\sum }_{i = 1}^{n} ( 1 - cos ( 2 π {y}_{i} ) ) ) \\ subject to & y = ( {y}_{1} , … , {y}_{n} ) ∈ {Z}^{n}\end{matrix} \qquad ( 2.7 )$$

The Rosenbrock function (2.5) has been tested for n=10, 20, and 30, the Griewank function (2.6) has been tested for n=10, 30, and 60, and the Rastrigin function (2.7) has been tested for n=30, 60, and 100. To facilitate the comparison, the computation has been carried out for 10 independent runs by these two methods. During each run, the same initial point is assigned to both methods. To assess the solution quality, statistics including the mean, minimum, maximum and standard deviation of the computing time (in seconds), of the objective function value, and of the number of solved relaxed continuous problems are evaluated over the solutions obtained in the 10 runs.

The detailed results are summarized below. The first part of difference can be observed by comparing the mean objective function values attained by the two methods on these benchmark functions. For all the benchmark functions, the B&B method failed to achieve the global optimal solution (which is 0), though it achieved the global optimal solution in some tests with small values of n. Moreover, as the value of n increase, that is, as the problem complexity increases, the mean objective values obtained by the B&B method tend to increase as well. In other words, the solution quality of the B&B method will degrade as the problem complexity increases, indicating that the solutions be far away from the global optimal solution. In contrast, in terms of the mean objective function value, the TRUST-TECH guided B&B method can successfully achieve the global optimal solution, which is 0, for seven of the nine test cases in these examples. For the remained two cases, that is, for the Griewank function with n=10 and n=30, the mean objective function values obtained by the TRUST-TECH guided B&B method are 0.02 and 0.0049, respectively. Indeed, they are very close to the global optimal solution. Therefore, the TRUST-TECH guided B&B method is indeed able to compute the global optimal solution to MINLP problems and is much less sensitive to the problem complexity.

The second part of difference can be observed from the computing time required by the two methods. For eight of the nine test cases, the TRUST-TECH guided B&B method requires much less computing time than the B&B method, especially for large-scale problems. For example, for the Rastrigin function with n=100, the B&B method requires more than 20 hours (72949 seconds) on average to solve the problem (not to mention its solutions are far away from the global optimal solution). In contrast, the TRUST-TECH guided B&B method requires only less than 10 minutes (533 seconds) to achieve the global optimal solution. The ratio between the computing time required by the two methods is almost 137:1. The only exception is for the Rosenbrock function with n=10, where the B&B method requires less computing time (8.16 seconds) than the TRUST-TECH guided method (17.95 seconds). However, the difference is not significant, especially considering that the TRUST-TECH guided method achieved the global optimal solution, while the B&B method failed.

The difference between computational efficiency of the two methods can also be reflected by the difference between the numbers of relaxed continuous problems that are solved in their solution processes. For all of the nine test cases, the TRUST-TECH guided B&B method requires to solve only a small fractional number of relaxed continuous problems than that required by the B&B method. For instance, for the Rastrigin function with n=60, there were 36001 relaxed continuous problems on average need to be solved by the B&B method, while the objective function value, which is 8493 on average, is still very far away from the global optimal solution. In contrast, the TRUST-TECH guided B&B method needed only to solve 251.6 relaxed continuous problems and attained the global optimal solution. Such a significant reduction in the number of relaxed continuous problems is a direct consequence of the rapidly tightened upper bound after incorporating TRUST-TECH into the B&B search procedure. Acceleration in convergence to the global optimal solution renders the TRUST-TECH guided B&B method scalable very well to large-scale problems.

Furthermore, in terms of the standard deviations or the dynamic ranges (i.e., the difference between the maximum and the minimum) of all of the involved performance values (i.e., computing time, objective function value, and number of solved relaxed continuous problems), the values of the TRUST-TECH guided B&B method are significantly smaller than that of the B&B method. Especially for the Rastrigin function with n=100, the standard deviation of the computing time is 31.34 second for the TRUST-TECH guided B&B, compared to 6937.94 seconds for the B&B method. Such a difference indicates that the results returned by the TRUST-TECH guided B&B method are much more consistent than that by the B&B method. In other words, the TRUST-TECH guided B&B method is very stable and robust for MINLP problems of different complexities.

In summary, the TRUST-TECH guided methods have the following distinctive features:

1) The existing MINLP solvers (such as B&B and its variants) can solve an MINLP problem provided that the problem is convex or the integer solution is restricted to a stability region in the dynamical system associated with the relaxed continuous problem. TRUST-TECH leads the search from a stability region where an integer solution is located to another nearby stability region, which contains one or more other integer solutions. Within this nearby stability region, an existing MINLP solver can be used to compute one or more other integer solutions.

2) A comprehensive set of multi-tier SEPs in a dynamical system associated with a relaxed continuous problem of the MINLP problem is computed and serves as initial points to the B&B (or its variant) method, and any improved integer solution is promptly used as the upper bound in succeeding searches. Imposing this upper bound in turn results in most of the multi-tier SEPs being identified as inferior and thus being discarded. In this manner, the upper bound for the B&B (or its variant) method can be tightened very quickly.

3) As the major contribution of the tightened upper bound, the integer solution returned by the TRUST-TECH guided methods achieve better solutions. In the meantime, these better solutions can be attained in the early stage. In other words, the TRUST-TECH guided methods can consistently achieve significantly improved solution quality and computational efficiency than conventional B&B (or its variant) methods.

4) The TRUST-TECH dynamic search procedure is parallel in nature; that is, searches in different directions can be performed in parallel. Therefore, the TRUST-TECH guided methods are ready for parallel implementations, so as to take full advantage of fast-growing hardware capabilities.

5) The above description uses the B&B (or its variant) method as examples of the existing MINLP solver. Nevertheless, the TRUST-TECH guided methods are widely applicable, in that any other solution method or commercial solver for MINLP problems can be guided in a similar manner to achieve improved solution quality.

Embodiments of the techniques disclosed herein may be implemented in hardware, software, firmware, or a combination of such implementation approaches. In one embodiment, the methods described herein may be performed by a processing system. A processing system includes any system that has a processor, such as, for example; a digital signal processor (DSP), a microcontroller, an application specific integrated circuit (ASIC), or a microprocessor. One example of a processing system is a computer system.

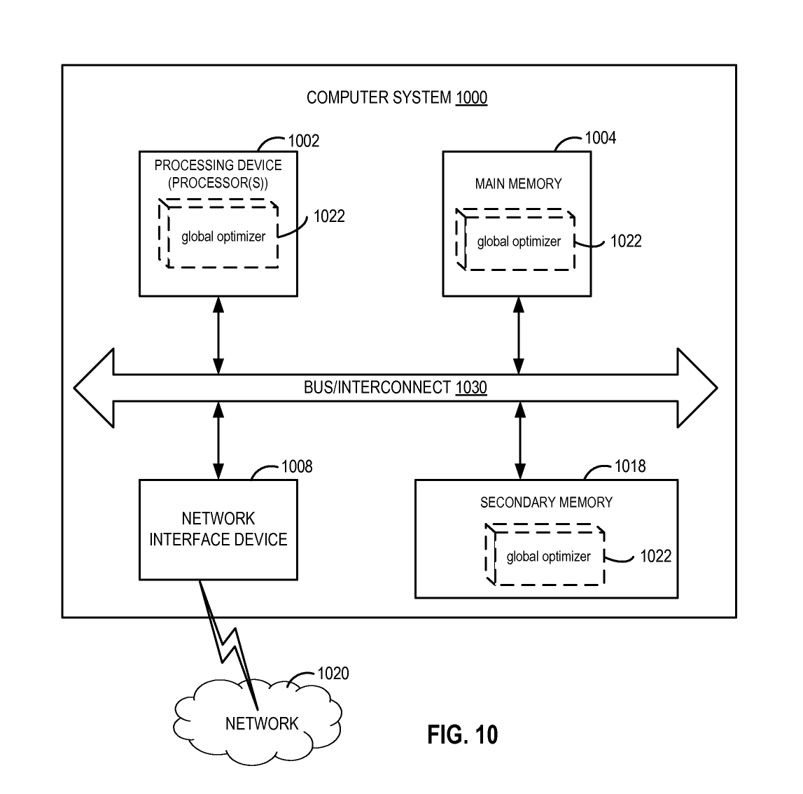

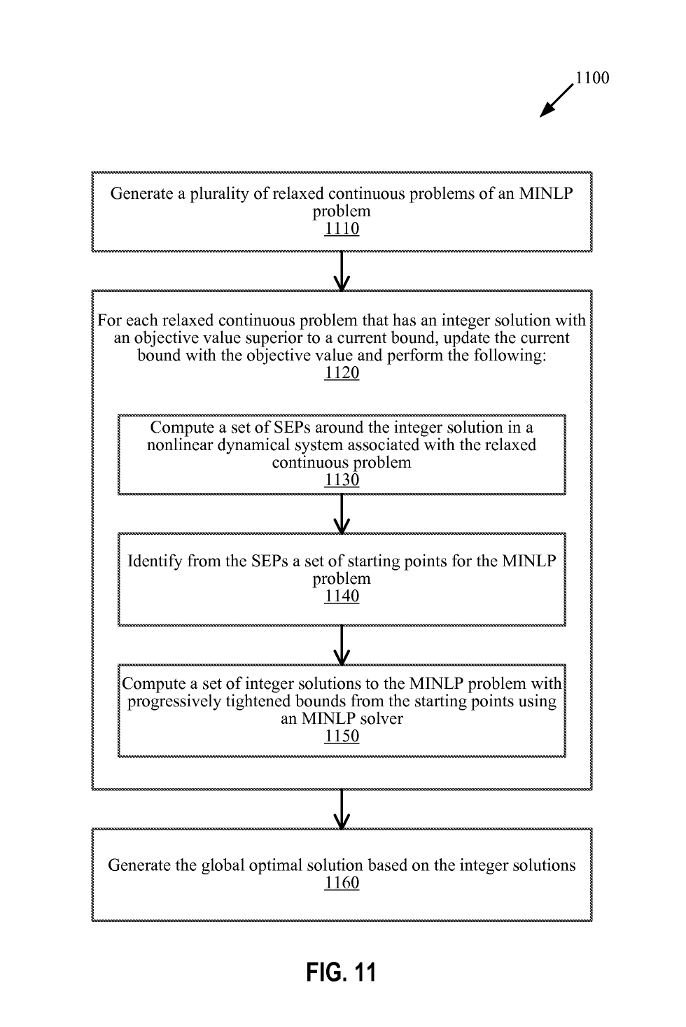

FIG. 10 illustrates a diagrammatic representation of a machine in the form of a computer system 1000 within which a set of instructions, for causing the machine to perform any one or more of the methodologies discussed herein, may be executed. The computer system 1000 may be a server computer, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The computer system 1000 includes a processing device 1002. The processing device 1002 represents one or more general-purpose processors, each of which can be: a microprocessor, a central processing unit (CPU), a multicore system, or the like. More particularly, the processing device 1002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. The processing device 1002 may also be one or more special-purpose processing devices such as an application specific integrated circuit (ASIC), a field programmable gate array (FPGA), a digital signal processor (DSP), network processor, or the like. In one embodiment, the processing device 1002 is adapted to execute the operations of a global optimizer 1022, which performs the methods described in connection with FIG. 2, FIG. 3, FIG. 8 and/or FIG. 11 for generating a global optimal solution for an MINLP problem.

In one embodiment, the processor device 1002 is coupled to one or more memory devices such as: a main memory 1004 (e.g., read-only memory (ROM), flash memory, dynamic random access memory (DRAM), a secondary memory 1018 (e.g., a magnetic data storage device, an optical magnetic data storage device, etc.), and other forms of computer-readable media, which communicate with each other via a bus or interconnect. The memory devices may also different forms of read-only memories (ROMs), different forms of random access memories (RAMs), static random access memory (SRAM), or any type of media suitable for storing electronic instructions. In one embodiment, the memory devices may store the code and data of the global optimizer 1022. In the embodiment of FIG. 10, the global optimizer 1022 may be located in one or more of the locations shown as dotted boxes and labeled by the reference numeral 1022.

The computer system 1000 may further include a network interface device 1008. A part or all of the data and code of the global optimizer 1022 may be transmitted or received over a network 1020 via the network interface device 1008. Although not shown in FIG. 10, the computer system 1000 also may include user input/output devices (e.g., a keyboard, a touchscreen, speakers, and/or a display).

In one embodiment, the global optimizer 1022 can be implemented using code and data stored and executed on one or more computer systems (e.g., the computer system 1000). Such computer systems store and transmit (internally and/or with other electronic devices over a network) code (composed of software instructions) and data using computer-readable media, such as non-transitory tangible computer-readable media (e.g., computer-readable storage media such as magnetic disks; optical disks; read only memory; flash memory devices as shown in FIG. 10 as 1004 and 1018) and transitory computer-readable transmission media (e.g., electrical, optical, acoustical or other form of propagated signals such as carrier waves, infrared signals). A non-transitory computer-readable medium of a given computer system typically stores instructions for execution on one or more processors of that computer system. One or more parts of an embodiment of the invention may be implemented using different combinations of software, firmware, and/or hardware.

FIG. 11 is a flow diagram illustrating an example of a method 1100 for generating a global optimal solution to an MINLP problem wherein a part or all of optimization variables of the MINLP problem are restricted to have discrete values. The method 1100 can be executed by software, hardware, firmware, or a combination thereof. In one embodiment, the method 1100 is executed by a processing system such as a computer system.

According to FIG. 11, in one embodiment, the method 1100 begins with generating a plurality of relaxed continuous problems of the MINLP problem (block 1110). For each of the relaxed continuous problems that has an integer solution with an objective value superior to a current bound, the method proceeds to update the current bound with the objective value and perform the following (block 1120): compute a set of SEPs around the integer solution in a nonlinear dynamical system associated with the relaxed continuous problem (block 1130); identify from the SEPs a set of starting points for the MINLP problem (block 1140); and compute a set of integer solutions to the MINLP problem with progressively tightened bounds from the starting points using an MINLP solver (block 1150). The method further proceeds to generate the global optimal solution based on the integer solutions (block 1160).

The operations of the methods of FIG. 2, FIG. 3, FIG. 8 and FIG. 11 have been described with reference to the exemplary embodiment of FIG. 10. However, it should be understood that the operations of the methods of FIG. 2, FIG. 3, FIG. 8 and FIG. 11 can be performed by embodiments of the invention other than those discussed with reference to FIG. 10, and the embodiment discussed with reference to FIG. 10 can perform operations different from those discussed with reference to the methods of FIG. 2, FIG. 3, FIG. 8 and FIG. 11. While the methods of FIG. 2, FIG. 3, FIG. 8 and FIG. 11 show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A computer-implemented method for generating a global optimal solution to a mixed integer nonlinear programming (MINLP) problem wherein a part or all of optimization variables of the MINLP problem are restricted to have discrete values, the method comprising:
generating by a computer system a plurality of relaxed continuous problems of the MINLP problem;
for each of the relaxed continuous problems that has an integer solution with an objective value superior to a current bound, updating the current bound with the objective value and performing the following:
computing a set of stable equilibrium points (SEPs) around the integer solution in a nonlinear dynamical system associated with the relaxed continuous problem;
identifying from the SEPs a set of starting points for the MINLP problem; and
computing a set of integer solutions to the MINLP problem with progressively tightened bounds from the starting points using an MINLP solver; and
generating by the computer system the global optimal solution based on the integer solutions.

2. The method of claim 1, wherein the MINLP solver is a Branch-and-Bound method, a Branch-and-Reduce method, or another existing MINLP solver.

3. The method of claim 1, wherein computing the set of SEPs further comprises:
constructing the nonlinear dynamical system such that local optimal solutions to a relaxed continuous problem correspond to distinct SEPs of the nonlinear dynamical system.

4. The method of claim 1, wherein each of the starting points is one of the SEPs that has an objective value superior to the current bound.

5. The method of claim 1, wherein the set of SEPs are multi-tiered, and wherein the set of SEPs are computed in a deterministic and tier-by-tier manner.

6. The method of claim 1, wherein generating the plurality of relaxed continuous problems further comprises: generating additional relaxed continuous problems for each of the relaxed continuous problems whose solution is non-integer.

7. The method of claim 1, wherein generating additional relaxed continuous problems further comprises: subdividing a coordinate for a relaxed continuous problem that has a non-integer solution to produce subdivided ranges of the coordinate, wherein the sub-dividing takes place at a integer point immediately adjacent to the non-integer solution, and wherein each subdivided range corresponds to an additional relaxed continuous problem.

8. The method of claim 1 further comprising: computing the SEPs in one or more of search directions in parallel.

9. The method of claim 1, wherein the MINLP problem is associated with an objective function and one or more constraint functions, wherein at least one of the objective function and the constraint functions is nonlinear and nonconvex.

10. A system for generating a global optimal solution to a mixed integer nonlinear programming (MINLP) problem wherein a part or all of optimization variables of the MINLP problem are restricted to have discrete values, the system comprising:
one or more processors; and
one or more memory devices coupled to the one or more processors, wherein the one or more processors are adapted to perform operations of a global optimizer to:
generate a plurality of relaxed continuous problems of the MINLP problem;
for each of the relaxed continuous problems that has an integer solution with an objective value superior to a current bound, update the current bound with the objective value, compute a set of stable equilibrium points (SEPs) around the integer solution in a nonlinear dynamical system associated with the relaxed continuous problem, identify from the SEPs a set of starting points for the MINLP problem, and compute a set of integer solutions to the MINLP problem with progressively tightened bounds from the starting points using an MINLP solver; and
generate the global optimal solution based on the integer solutions.

11. The system of claim 10, wherein the MINLP solver is a Branch-and-Bound method, a Branch-and-Reduce method, or another existing MINLP solver.

12. The system of claim 10, wherein the one or more processors are adapted to perform the operations of the global optimizer to construct the nonlinear dynamical system such that each of local optimal solutions to the relaxed continuous problem corresponds to a distinct SEP of the nonlinear dynamical system.

13. The system of claim 10, wherein each of the starting points is one of the SEPs that has an objective value superior to the current bound.

14. The system of claim 10, wherein the set of SEPs are multi-tiered, and wherein the set of SEPs are computed in a deterministic and tier-by-tier manner.

15. The system of claim 10, wherein the one or more processors are adapted to perform operations of a global optimizer to generate additional relaxed continuous problems for each of the relaxed continuous problems whose solution is non-integer, and subdivide a range of coordinates of the relaxed continuous problem whose solution is non-integer, wherein each subdivided range of coordinates corresponds to an additional relaxed continuous problem.

16. The system of claim 10, wherein the one or more processors are adapted to perform operations of a global optimizer to compute the SEPs in one or more of search directions in parallel.

17. The system of claim 10, wherein the MINLP problem is associated with an objective function and one or more constraint functions, wherein at least one of the objective function and the constraint functions is nonlinear and nonconvex.

18. A computer readable storage medium including instructions that, when executed by a processing system, cause the processing system to perform a method for generating a global optimal solution to a mixed integer nonlinear programming (MINLP) problem wherein a part or all of optimization variables of the MINLP problem are restricted to have discrete values, the method comprising:
generating a plurality of relaxed continuous problems of the MINLP problem;
for each of the relaxed continuous problems that has an integer solution with an objective value superior to a current bound, updating the current bound with the objective value and performing the following:
computing a set of stable equilibrium points (SEPs) around the integer solution in a nonlinear dynamical system associated with the relaxed continuous problem;
identifying from the SEPs a set of starting points for the MINLP problem; and
computing a set of integer solutions to the MINLP problem with progressively tightened bounds from the starting points using an MINLP solver; and
generating the global optimal solution based on the integer solutions.

19. The computer readable storage medium of claim 18, wherein the MINLP solver is a Branch-and-Bound method, a Branch-and-Reduce method, or another existing MINLP solver.

20. The computer readable storage medium of claim 18, wherein generating the plurality of relaxed continuous problems further comprises:
generating additional relaxed continuous problems for each of the relaxed continuous problems whose solution is non-integer; and
subdividing a range of coordinates of the relaxed continuous problem whose solution is non-integer, wherein each subdivided range of coordinates corresponds to an additional relaxed continuous problem.
